(19) United States
(12) Patent Application Publication
(10) Pub. No.: US 2014/0216892 A1
(43) Pub. Date: Aug. 7, 2014

(54) MATERIAL TRANSFER DEVICE

(71) Applicant: HON HAI PRECISION INDUSTRY CO., LTD., New Taipei (TW)

(72) Inventor: MING-LUNG GUO, New Taipei (TW)

(73) Assignee: HON HAI PRECISION INDUSTRY CO., LTD., New Taipei (TW)

(21) Appl. No.: 14/144,569

(22) Filed: Dec. 31, 2013

(30) Foreign Application Priority Data
Feb. 4, 2013 (TW) 102104119

(51) Int. Cl. B65G 25/08

(52) U.S. Cl. CPC B65G 25/08
USPC 198/339.1

(57) ABSTRACT

A material transfer device is configured for transferring a number of molding assemblies. The material transfer device includes a controlling box and a transfer mechanism. The transfer mechanism includes a receiving chamber, a driving device, and a supporting structure. The receiving chamber is fixedly positioned on the controlling box. The driving device is positioned on a side surface of the receiving chamber. The supporting structure includes a holder and a supporting plate. The holder is positioned on the driving device, and configured to hold the molding assemblies. The supporting plate is positioned on the holder. The driving device drives the supporting structure to move, relative to the receiving chamber.

### BACKGROUND

1. Technical Field

The present disclosure relates to a material transfer device.

2. Description of Related Art

Injection molding products, such as lenses, are molded in a runner system, after the runner system needs to be positioned on a retainer of a shearing machine for shearing the molded lenses. In related art, the molded lenses are manually positioned on the shearing machine for shearing, this is inconvenient.

Therefore, it is desirable to provide a material transfer device which can overcome the above-mentioned limitations.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is an assembled, isometric view of a material transfer device, according to an exemplary embodiment.

FIG. 2 is an exploded, isometric view of the material transfer device of FIG. 1.

FIG. 3 is an exploded, isometric view of a supporting structure of FIG. 2.

FIG. 4 is similar to FIG. 1, but is in a use state.

### DETAILED DESCRIPTION

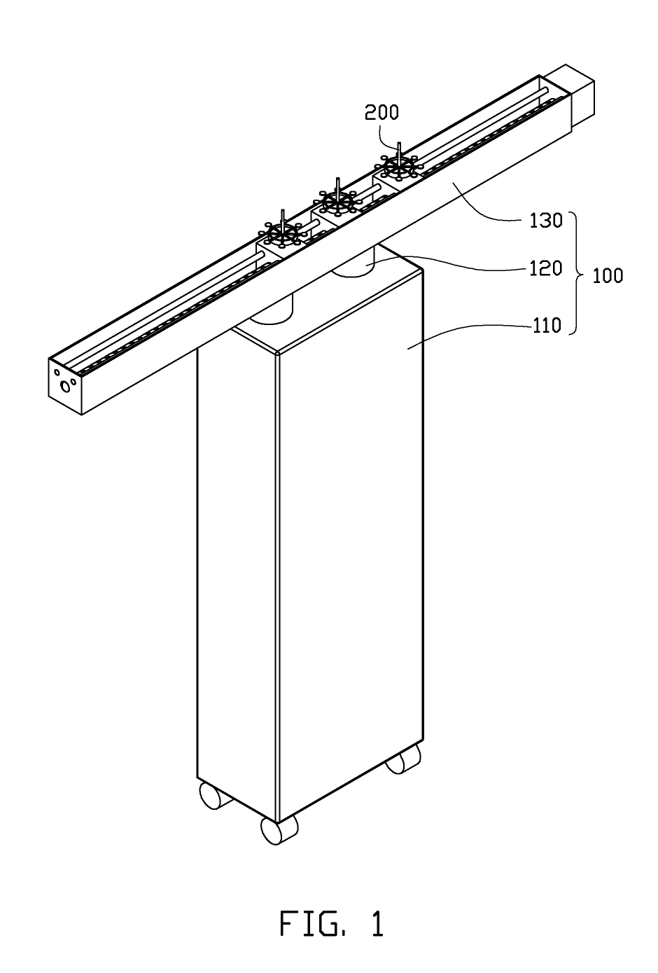

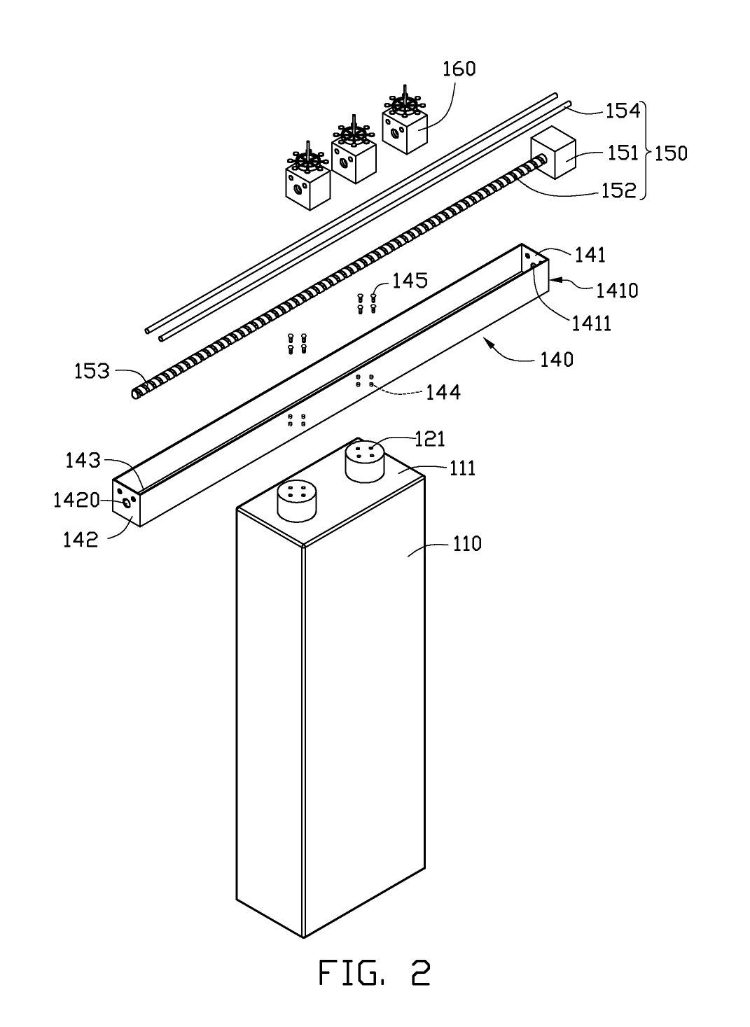

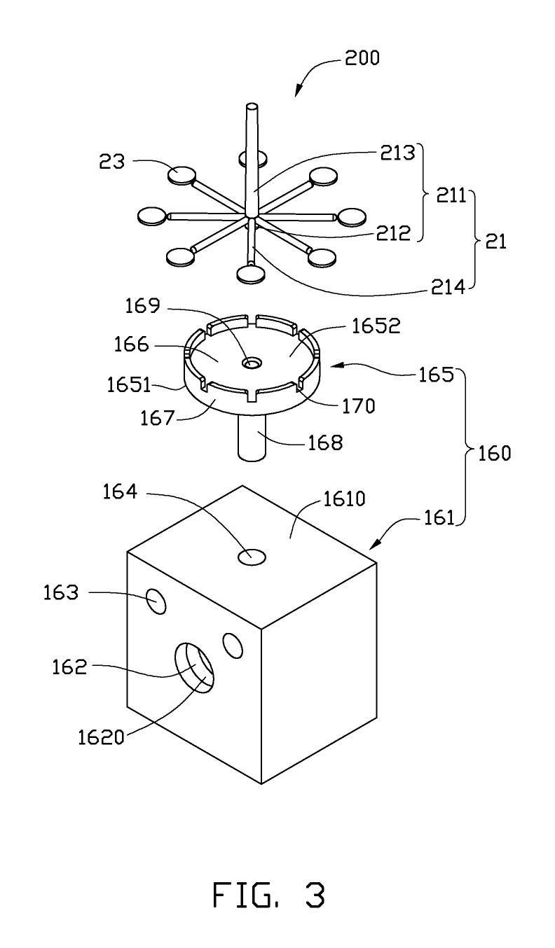

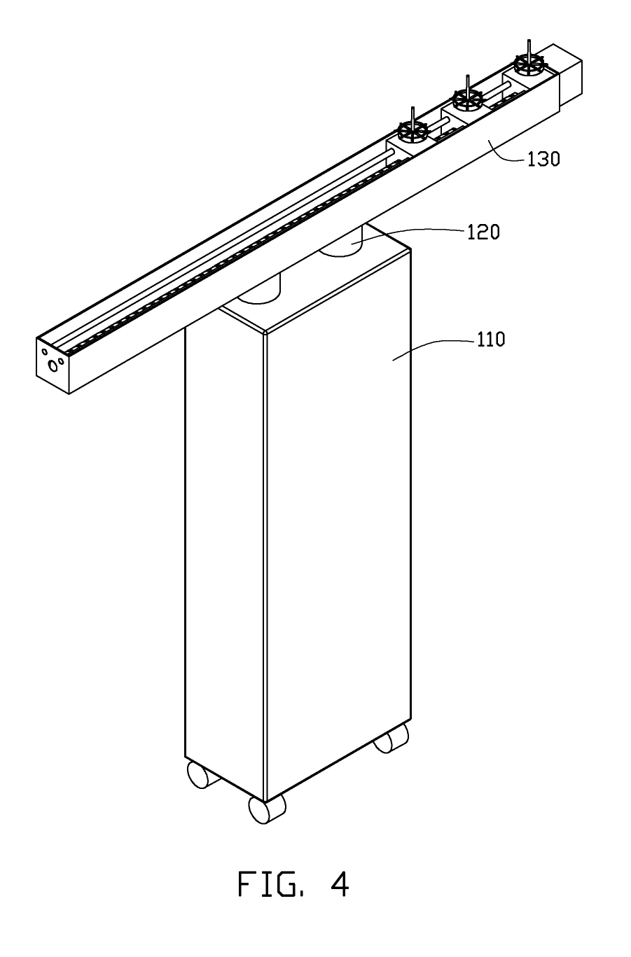

FIGS. 1-4 show an embodiment of a material transfer device 100 for transferring a number of molding assemblies 200. Each molding assembly 200 includes a runner system 21 and six molded products 23. The runner system 21 includes a main channel 211 and six branch channels 214 positioned equidistantly around the main channel 211. The main channel 211 includes a first end portion 212 and a second end portion 213. The four branch channels 214 are positioned between the first end portion 212 and the second end portion 213. One end of the branch channel 214 is connected to the main channel 211, and the other end of the branch channel 214 is connected to a molded product 23. In one embodiment, the molded product 23 is a molded lens.

The material transfer device 100 includes a controlling box 110, two supporting poles 120, and a transfer mechanisml30.

The controlling box 110 is substantially cuboid, and includes a top plate 111.

The two supporting poles 120 are positioned on the top plate 111 and substantially perpendicular to the top plate 111. The two supporting poles 120 can be moved up and down relative to the top plate 111. The material transfer device 100 includes a lifting device received in the controlling box 110. The lifting device is connected to the supporting poles 120 for driving the supporting poles 120 to move up and down relative to the top plate 111. In one embodiment, each supporting pole 120 defines four locating holes 121.

The transfer mechanism 130 is positioned on an end of the supporting pole 120 away from the top plate 111. The transfer mechanism 130 includes a receiving chamber 140, a driving device 150 and three supporting structures 160.

The receiving chamber 140 is cuboid, and includes a first side plate 141, a second side plate 142, and a bottom plate 143. The first side plate 141 is substantially parallel to the second side plate 142. The bottom plate 143 substantially perpendicularly connects the first side plate 141 and the second side plate 142. The bottom plate 143 is fixedly positioned on the supporting poles 120. The first side plate 141 defines a first receiving hole 1411. The second side plate 142 defines a second receiving hole 1420 aligning with the first receiving hole 1411. In one embodiment, the bottom plate 143 defines eight through holes 144. Each through hole 144 spatially corresponds to a locating hole 121. Eight bolts 145 runs through the eight through holes 144 and threadedly engages with the eight locating holes 121. As such, the receiving chamber 140 is fixedly positioned on the supporting pole 120.

The driving device 150 includes a motor 151, a screw pole 152, and two guiding poles 154. The motor 151 is mounted on an external surface 1410 of the first side plate 141. One end of the screw pole 152 runs through the first receiving hole 1411 and is connected to the motor 151. The other end of the screw pole 152 is rotatably received in the second receiving hole 1420 of the second side plate 142. The motor 151 is configured to drive the screw pole 152 to rotate. The screw pole 152 includes a number of external screws 153 formed on an external surface of the screw pole 152. The two guiding poles 154 are located at two sides of the screw pole 152. One end of the guiding pole 154 is connected to an internal side surface of the first side plate 141. The other end of the guiding pole 154 is connected to an internal side surface of the second side plate 142.

Each supporting structure 160 includes a holder 161 and a supporting plate 165. The holder 161 is connected to the supporting plate 165. A width of the holder 161 is substantially equal to that of the receiving chamber 140. The holder 161 together with the supporting plate 165 can be moved along the guiding poles 154, being driven by the motor 151.

Each holder 161 is substantially cuboid, and defines an internal threaded hole 162 passing two opposite sidewalls, and two guiding holes 163 also passing the two opposite sidewalls. A top surface 1610 of the holder 161 defines a receiving hole 164. The internal threaded hole 162 forms a number of internal screws 1620 matching with the external screws 153. The external screws 153 of the screw pole 152 threadedly engage with the internal screws 1620, therefore, the screw pole 152 penetrates through the three holders 161, and each guiding pole 154 penetrates through a corresponding guiding hole 163.

Each supporting plate 165 is configured to support a corresponding molding assemblies 200. The supporting plate 165 includes a connection plate 166 and a circular holding plate 167. The connection plate 166 is connected to the holder 161. In one embodiment, the connection plate 166 includes a lower surface 1651 and an upper surface 1652 facing away from the lower surface 1651. The supporting plate 165 also includes a position pole 168 substantially perpendicularly extending from the lower surface 1651. The position pole 168 is tightly received in the receiving hole 164 of the holder 161. As such, the supporting plate 165 is connected to the holder 161.

The upper surface 1652 of the supporting surface 165 defines a receiving cavity 169 for receiving the first end portion 212 of the main channel 211.

The holding plate 167 substantially perpendicularly extends from the upper surface 1652. The holding plate 167 defines six holding cavities 170 spatially corresponding to the six branch channels 214. Each holding cavity 170 is configured to hold a corresponding branch channel 214.

In use, the motor 151 rotates the screw pole 152, as such, the supporting structures 160 move along the guiding poles 154 toward a shearing machine for shearing the molded products 23.

In other embodiments, the number of the guiding poles 154 can be changed depending on need, and the number of the guiding holes 163 of each holder 161 will change correspondingly.

In other embodiments, the supporting poles 120 can be omitted, the receiving chamber 140 directly positioned on the top plate 111.

It will be understood that the above particular embodiments are shown and described by way of illustration only. The principles and the features of the present disclosure may be employed in various and numerous embodiment thereof without departing from the scope of the disclosure as claimed. The above-described embodiments illustrate the possible scope of the disclosure but do not restrict the scope of the disclosure.

What is claimed is:

1. A material transfer device configured for transferring a plurality of molding assemblies, the material transfer device comprising:
a controlling box; and
a transfer mechanism comprising a receiving chamber, a driving device, and a supporting structure, the receiving chamber fixedly positioned on the controlling box, the driving device positioned on a side surface of the receiving chamber, the supporting structure comprising a holder and a supporting plate, the holder positioned on the driving device, and configured to hold the molding assemblies, the supporting plate positioned on the holder, wherein the driving device drives the supporting structure to move relative to the receiving chamber.

2. The material transfer device of claim 1, comprising two supporting poles, wherein the controlling box comprises a top plate, the two supporting poles are positioned on the top plate and substantially perpendicular to the top plate, the receiving chamber is positioned on the top plate, the two supporting poles are capable of being moved up and down relative to the top plate to adjust the transfer mechanism.

3. The material transfer device of claim 2, wherein the transfer mechanism is positioned on an end of each of the supporting poles away from the top plate.

4. The material transfer device of claim 2, wherein the receiving chamber comprises a first side plate, a second side plate, and a bottom plate, the first side plate is substantially parallel to the second plate, the bottom plate substantially perpendicularly connects the first side plate and the second side plate, the bottom plate is fixedly positioned on the supporting poles.

5. The material transfer device of claim 4, wherein the driving device comprises a motor, a screw pole, and at least one guiding pole, the screw pole is connected to the motor, each holder is coiled around the screw pole, the holder together with the supporting plate are capable of moving along the at least one guiding pole, being driven by the motor.

6. The material transfer device of claim 5, wherein the first side plate defines a first receiving hole, the second side plate defines a second receiving hole aligning with the first receiving hole, one end of the screw pole runs through the first receiving hole and is connected to the motor, the other end of the screw pole is rotatably received in the second receiving hole.

7. The material transfer device of claim 6, wherein the screw pole comprises a plurality of external screws formed on an external surface of the screw pole, each holder defines an internal threaded hole passing two opposite sidewalls, the internal threaded hole forms a plurality of internal screws matching with the external screws, the external screws of the screw pole threadedly engage with the internal screws, the screw pole penetrates through the holders.

8. The material transfer device of claim 7, wherein each holder defines at least one guiding hole also passing the two opposite sidewalls, each guiding pole locates at a side of the screw pole, each guiding pole penetrates through a corresponding guiding hole, one end of each guiding pole is connected to an internal side surface of the first side plate, the other end of each guiding pole is connected to an internal side surface of the second side plate.

9. The material transfer device of claim 1, wherein a width of the holder is substantially equal to that of the receiving chamber.

10. The material transfer device of claim 1, wherein the holder comprises a top surface, the top surface defines a receiving hole, the supporting plate comprises a connection plate, the supporting plate comprises a position pole substantially perpendicularly extending from a lower surface of the connection plate, the position pole is tightly received in the receiving hole of the holder.

11. The material transfer device of claim 10, wherein the connection plate comprises an upper surface facing away from the lower surface, the upper surface defines a receiving cavity.

12. The material transfer device of claim 11, wherein the supporting plate comprises a holding plate substantially perpendicularly extending from the upper surface, the holding plate defines a plurality of holding cavities.
